(19) United States
(12) Patent Application Publication
(10) Pub. No.: US 2005/0256776 A1
(43) Pub. Date: Nov. 17, 2005

(54) Industrial it system for production of distribution power transformers

(76) Inventors: Deia Salah-Eldin Bayoumi, Fuquay Varina, NC (US); William J. Vick, Cary, NC (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/513,078

(22) PCT Filed: Apr. 30, 2003
(86) PCT No.: PCT/US03/13532

§ 371 Date: Jun. 2, 2005

Related U.S. Application Data
(60) Provisional application No. 60/377,251, filed on Apr. 30, 2002.
(60) Provisional application No. 60/377,235, filed on Apr. 30, 2002.
(60) Provisional application No. 60/377,047, filed on Apr. 30, 2002.
(60) Provisional application No. 60/377,241, filed on Apr. 30, 2002.
(60) Provisional application No. 60/377,246, filed on Apr. 30, 2002.

(51) Int. Cl. G06F 17/60

(52) U.S. Cl. 705/26

(57) ABSTRACT

An order for a product from a customer by way of a website viewed on a display device of a customer computer is received and reviewed. An optimization across a plurality of manufacturing plants is requested, where each plant has a product manufacturing capacity, and the optimization takes place according to the capacity. The optimization is then received and a determination whether to confirm the order is made. If the order is confirmed, materials are ordered and a hold is placed on all or part of the capacity. Finally, an automated payment process is initiated with the customer.

### CROSS REFERENCE TO RELATED APPLICATIONS

This application claims priority under 35 U.S.C. § 119 (e) from the following U.S. provisional applications all of which were filed on Apr. 30, 2002: Ser. No. 60/377,251 (Attorney Docket No. ABTT-0300/B020140); Ser. No. 60/377,235 (Attorney Docket No. ABTT-0301/B020170); Ser. No. 60/377,047 (Attorney Docket No. ABTT-0302/B020200); Ser. No. 60/377,241 (Attorney Docket No. ABTT-0303/B020210); Ser. No. 60/377,246 (Attorney Docket No. ABTT-0304/B020230). All of the above-listed U.S. provisional applications are incorporated by reference herein, in their entirety, for all purposes. This application is related to the following PCT applications all of which were filed on Apr. 30, 2003: Attorney Docket No. ABTT-0376/B020230; Attorney Docket No. ABTT-0377/B020210; Attorney Docket No. ABTT-0378/B020200; Attorney Docket No. ABTT-0379/B020170; Attorney Docket No. ABTT-0380/B020140. All of the above-listed U.S. applications are incorporated by reference herein, in their entirety, for all purposes.

### FIELD OF THE INVENTION

The invention relates to the field of material logistics and more specifically to the field of integrating supply systems with manufacturing material control.

### BACKGROUND OF THE INVENTION

Manufacturing of any detailed product is a complex process that requires extensive co-ordination between various entities, both within the same organization and outside the organization. Such manufacturing includes material need determiinations, cost negotiations, material availability determinations, and warehousing considerations, just to name a few. Each of these entities typically is responsible for discrete portions of the manufacturing process, including order processing, supplier integration, and process feedback. It follows, therefore, that manufacturing requires getting the right information to the right place at the right time. Today, some of discrete entities or processes of the manufacturing process are automated computing systems. However, the communication and integration among the various entities is lacking. Often this lack of integration is a result of the various different entities that are responsible for the many different aspects of the overall manufacturing process. As a result, completing the entire manufacturing process often requires extensive human interaction between each of the various discrete entities or processes.

In addition, the entity that is ultimately responsible for the end product often is at the mercy of the individual material suppliers. Yet, often the communication to the end product manufacturer from the discrete entities is inconsistent. This inconsistent communication leads to missed production deadlines and eventually the arduous process of identifying new suppliers. In addition, inventories kept by the end product manufacturer often have low visibility, such that material acquisition requests often come too late, especially for long lead time material items.

Therefore, there is a need to provide automation and communication among the discrete manufacturing processes in real-time, and to provide greater visibility of manufacturing inventories.

### SUMMARY OF THE INVENTION

The invention contemplates a system and method for communicating among entities of a manufacturing process. The system comprises a process tracking and workflow engine and a communications network. The process tracking and workflow engine includes at least one processing rule operating on manufacturing processing information. The communications network cooperates with the process tracking and workflow engine to transmit and receive data representative of the manufacturing communication information. The inventive system also may include a sales system for receiving a product request, where the product request is received from a customer and/or a field sales representative. Also, the communication network may be a local area network, a wide area network, a wireless network, and/or the Internet, or any combination of those. The process tracking and workflow engine determines available suppliers of material items to manufacture the product request, as well as determining the availability and cost associated with available suppliers. Also, the process tracking and workflow engine may select at least one supplier for each material item, and transmit an order to the selected suppliers. In addition, the process tracking and workflow engine may be integrated with at least one supplier's financial institution via the communication network. The inventive system also may include a factory inventory module and a management module both of which may be in communication with the process tracking and workflow engine.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary embodiments of the invention; however, the invention is not limited to the specific methods and instrumentalities disclosed. In the drawings:

FIG. 1 is a block diagram of an exemplary computing system that may support the present invention;

FIG. 1a is a block diagram of an exemplary network environment in which the present invention may be employed;

FIG. 1b is a block diagram illustrating the cooperation of various computing elements when generating resource optimization for power systems in a computing environment;

FIG. 2 is a block diagram of an integrated manufacturing system, according to the invention;

FIG. 3 is a block diagram of an exemplary ordering module in accordance with the present invention;

FIG. 4 is a flow diagram illustrating an exemplary ordering process in accordance with the present invention;

FIG. 5 is a block diagram of an exemplary manufacturing system in accordance with the present invention;

FIG. 6 is a block diagram of an exemplary method for performing a manufacturing optimization in accordance with the present invention;

FIG. 7 is an exemplary flow diagram describing just one illustrative embodiment for implementing the invention;

FIG. 8 is a block diagram example describing just one illustrative embodiment for implementing the invention;

FIGS. 9a-9c are block diagrams of alternate illustrative data flow operations between exemplary components in accordance with the present invention;

FIG. 10 is a block diagram of cooperating components of the customer tracking module described in FIG. 2, and how such components interact for tracking power distribution system equipment customers; and

FIG. 11 is a flow diagram of processing performed by the customer tracking module to execute customer relationship management and/or error tracking surrounding the sales of power distribution system equipment and/or services in accordance with the present invention.

### DETAILED DESCRIPTION OF ILLUSTRATIVE EMBODIMENTS

Illustrative Computing Environment

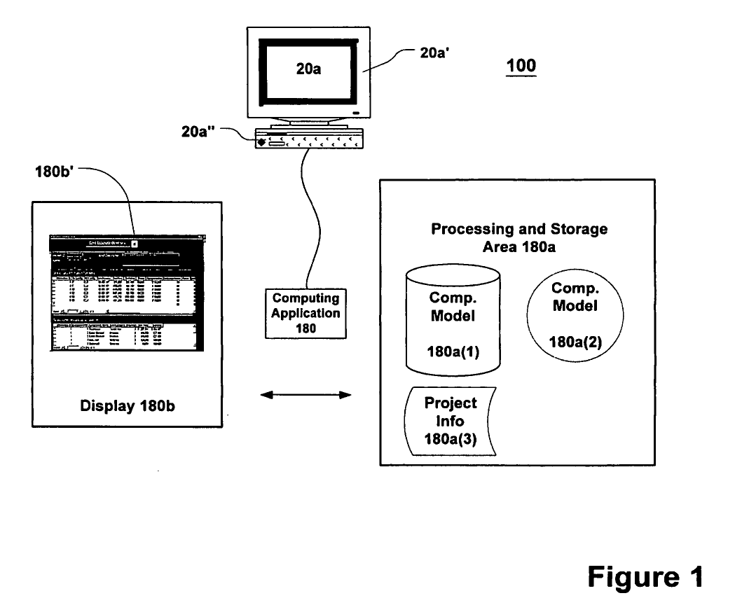

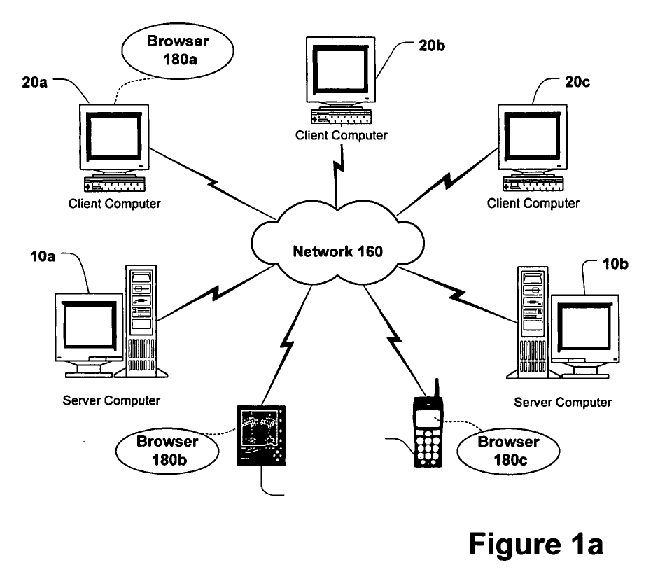

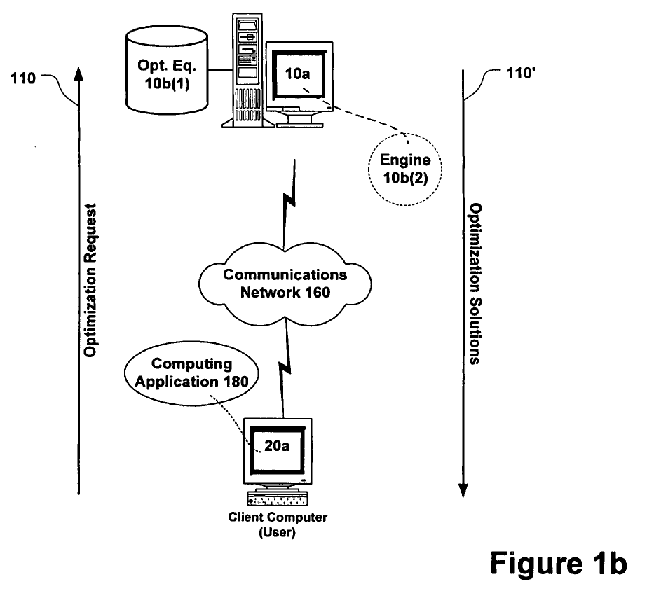

FIG. 1 shows computing system 100 that may support the present invention. Computing system 100 comprises computer 20a that may comprise display device 20a′ and interface and processing unit 20a″. Computer 20a may support computing application 180. As shown, computing application 180 may comprise computing application processing and storage area 180 and computing application display 180b. Computing application processing and storage area 180a may contain computational equation, rules, and models repository 180a(1), computational model engine 180a(2), and power system data store 180a(3). Similarly, computing application display 180b may comprise display content 180b′. In operation, a participating user (not shown) may interface with computing application 180 through the use of computer 20a. The participating user (not shown) may navigate through computing application 180 to input, display, and generate data representative of power system resource optimization. Resource optimization solutions and analysis may be created by computing application 180 using the computational equation, rules, and models repository 180a(1), computational model engine 180a(2), and power system information 180a(3) of computing application processing and storage area 180a and shown to a participating user (not shown) as display content 180b′ on computing application display 180b.

Illustrative Computer Network Environment

Computer 20a, described above, can be deployed as part of a computer network. In general, the above description for computers applies to both server computers and client computers deployed in a network environment. FIG. 1a illustrates an exemplary network environment, with a server in communication with client computers via a network, in which the present invention may be employed. As shown in FIG. 1a, a number of servers 10a, 10b, etc., are interconnected via a fixed-wire or wireless communications network 160 (which may be a LAN, WAN, intranet, the Internet, or other computer network) with a number of client computers 20a, 20b, 20c, or computing devices, such as, mobile phone 15, and personal digital assistant 17. In a network environment in which the communications network 160 is the Internet, for example, the servers 10 can be Web servers with which the clients 20 communicate via any of a number of known communication protocols, such as, hypertext transfer protocol (HTTP) or wireless application protocol (WAP). Each client computer 20 can be equipped with browser 180a to gain access to the servers 10. Similarly, personal digital assistant 17 can be equipped with browser 180b and mobile phone 15 can be equipped with browser 180c to display and receive various data.

In operation, a participating user (not shown) may interact with a computing application running on a client computing devices to generate resource optimization solutions for energy markets. The optimization solutions may be stored on server computers and communicated to cooperating users through client computing devices over communications network 160. A participating user may create, track, manage, and store project solutions and cost analysis information by interfacing with computing applications on client computing devices. These transactions may be communicated by client computing devices to server computers for processing and storage. Server computers may host computing applications for the processing of optimization information relevant to energy markets.

Thus, the present invention can be utilized in a computer network environment having client computing devices for accessing and interacting with the network and a server computer for interacting with client computers. However, the systems and methods providing resource optimization as described by the systems and methods disclosed herein can be implemented with a variety of network-based architectures, and thus should not be limited to the example shown. The systems and methods disclosed herein will be described in more detail with reference to a presently illustrative implementation.

Power System Solution Generation

FIG. 1b shows the cooperation of various computing elements when generating resource optimization for power systems in a computing environment. A participating user may employ computing application 180a operating on client computer 20a to send a request for resource optimization to project processing server 10a over communications network 160. In response, project processing server 10a may process the request by cooperating with adaptable and updateable computational equation, rules, and models data store 10b(1), and adaptable and updateable computational model engine 10b(2) to generate and communicate resource optimization solutions for the power system resource optimization request. The resource optimization solution information can then be communicated to client computer 20a over communications network 160. At client computer 20a, the resource optimization solution information may be viewed and manipulated by participating users.

Overview

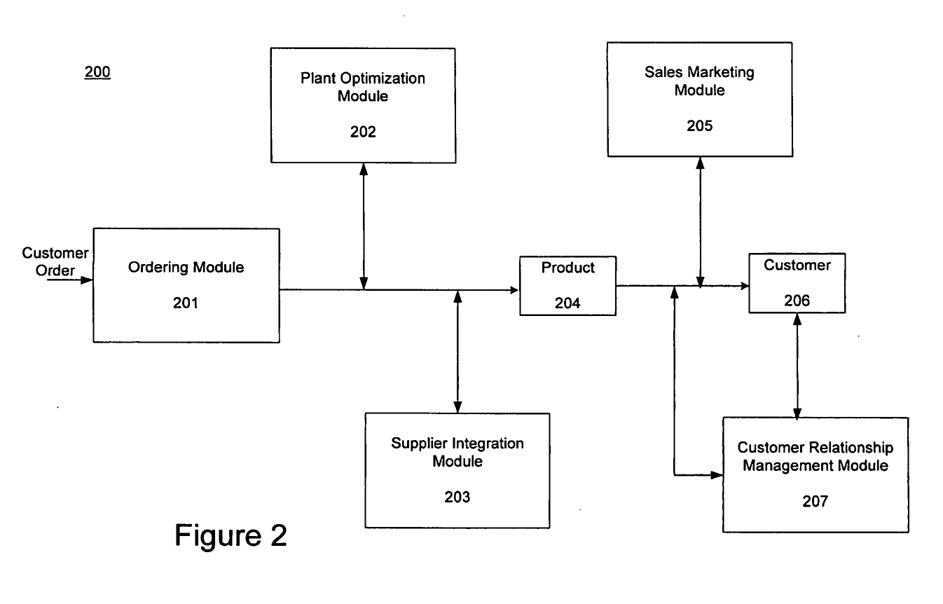

The invention contemplates a technique for integrating the inventory system of a manufacturing facility with each of the many material suppliers systems in real time. FIG. 2 is a block diagram of an integrated manufacturing system 200, according to the invention. It should be appreciated that the block diagram shown in FIG. 2 is just one example of a technique for accomplishing the invention. FIG. 2 is not meant to be the exclusive example, but is provided for the purpose of understanding the invention.

As shown in FIG. 2, a customer order enters ordering module 201. The customer order may be received electronically by ordering module 201 from a customer and/or a sales representative, for example, via a communications network 160 such as the Internet. As will be discussed in greater detail, ordering module 201 receives and processes the product order, and then routes the order for production and manufacturing. More specifically, plant optimization module 202 receives the order information from ordering module 201. As will be discussed in greater detail, plant optimization module 202 then determines which of the possible manufacturing plants would most effectively and/or efficiently manufacture the requested product. The order also is processed by supplier integration module 203. Supplier integration module 203, as will be discussed in greater detail below, considers the ordered product on a component-by-component basis and determines which of the available suppliers most efficiently and/or effectively will provide the component materials that eventually will be assembled to manufacture the end product. Product 204 represents the assembled end product, based on the customer order received by ordering module 201. Product 204 may then be delivered to the customer 206. Information may be gathered during the manufacture process by two additional modules, sales marketing module 205 and customer relationship management module 207. As will be described in more detail below, sales and marketing module 205 processes requests for quotes for various power distribution equipment and/or services to provide pricing information for a variety of equipment and/or services. Customer relationship management module 207 tracks and reports customer complaints and errors relating to the sale or performance of a power distribution system equipment and services.

Ordering Module

An embodiment of ordering module 201 is an online application that integrates the multiple processes that occur during the ordering and manufacturing of a power transformer into one streamlined process that also provides for real-time access and manipulation of ordering and manufacturing data. It should be noted that the details of implementing a website and/or intranet site in connection with electronic commerce should be known to one skilled in the art and is therefore not discussed herein for clarity.

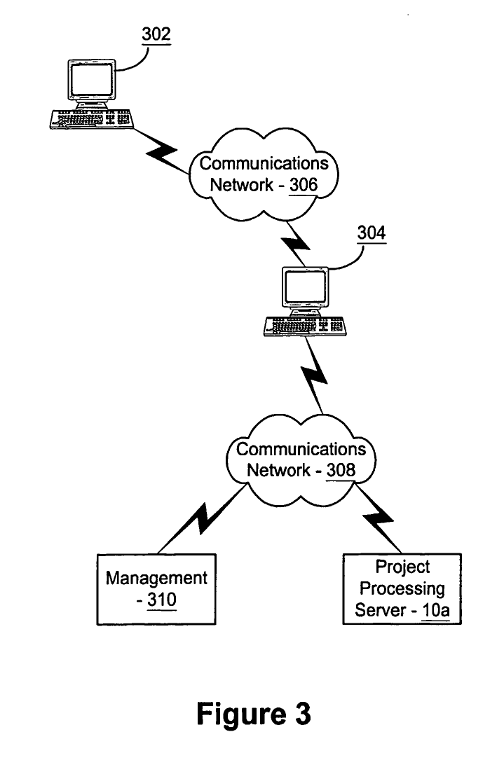

A block diagram of an exemplary ordering module 201 in accordance with the present invention is shown in FIG. 3. As shown, the exemplary ordering module includes a customer computer 302 which is connected to a sales computer 304 by way of a communications network 306. Such computers 302, 304 may be any computing device such as, for example, computer 20a as discussed above in connection with FIG. 1, a specialized computer or the like. Displayed on customer computer 302 may be a sales website 312 that provides predetermined transformer sales information to a customer and that may also permit the customer to transmit information to the sales computer 304. Communications network 306 may be any means for operatively connecting computers 302, 304 such as communications network 160.

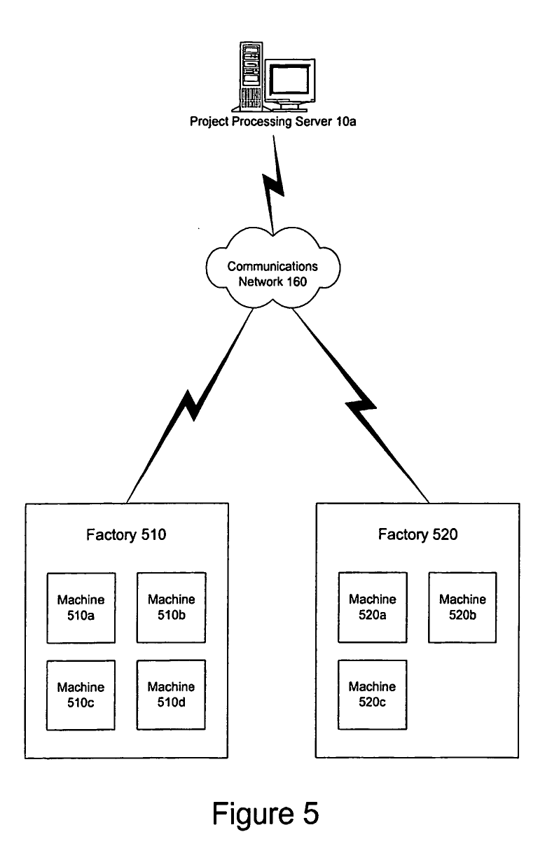

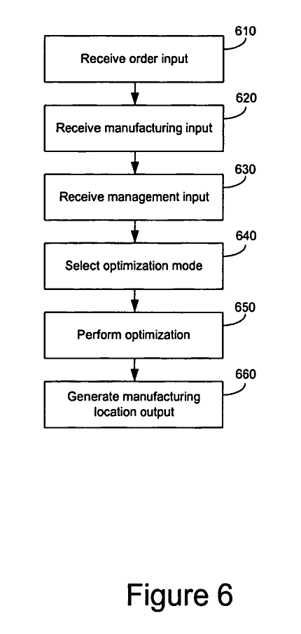

Operatively connected to sales computer 304 by way of communications network 308 may be management computer 310 and project processing server 10a Communications network 308 may be the same network as communications network 306, or may be a different network. Additionally, communications network 308 may be a different type of communications network 160 than communications network 306. Management computer 310 may be any computing device for communicating with a management entity of the transformer manufacturer. Such management computer 310, like computers 302, 304, may be any type of computing device, such as computer 20a, and may permit the management entity to send information to sales computer 304 by way of communications network 308. Sales computer 304 may process such management input, for example, according to predetermined criteria. Project processing server 10a enables functionality similar to that of management computer 310 with respect to a manufacturing entity of the transformer manufacturer and will be discussed below in greater detail in connection with FIGS. 5 and 6.

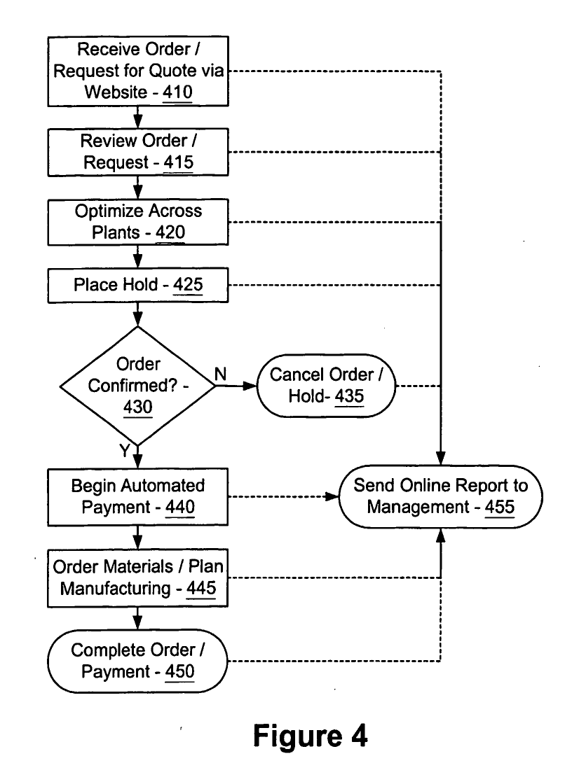

Turning now to FIG. 4, at step 410 an order or a request for quote for a transformer is received by way of sales website 312. Such an order or request may be performed in any number of ways. For example, a customer may fill out an online form on a manufacturer website 312, which is then sent to a website server associated with the manufacturer website. Alternatively, a customer may send a request by way of email or like. The order may contain any information relevant to the transformer order such as, for example, transformer characteristics, project information and/or shipping information. At some point during step 210, as well as at some point during steps 215-225 and 235-250, as will be discussed below, an online report may be sent to the management computer 310 at step 255. For example, if a customer fills out an online form to perform step 210, a copy of such form may be sent to both a manufacturing entity by way of the project processing server 10a, as well as a management entity by way of management computer 310. As may be appreciated, sending such a report, and the information contained in such report, may enable the creation of a trend analysis, historical analysis and/or the like. Furthermore, such a report enables management or another entity within the manufacturer to review a status associated with the transformer order or with the transformer's construction in real-time. In one embodiment, the customer may also have access to a manufacturer system such as project processing server 10a or the like so as to be able to review a status associated with the order.

At step 215, the order is reviewed. Such a review process may be performed manually by, for example, a sales engineer or the like, or the process may be automated. In an embodiment where a customer performed step 210 above in connection with sending an email, for example, a sales engineer or the like may review the order, correspond with the customer if necessary, and then enter the order into the manufacturing system such as project processing server 10a. In an embodiment where a customer performed step 210 above in connection with filling out an online form provided by website 312, for example, the form may be reviewed by sales computer 304 or the like and automatically forwarded, if valid, to project processing server 10a or another manufacturer computer 10a. A pre-review is also possible, where a customer is only permitted to, for example, select valid options for ordering one or more transformers. The options may be based on valid transformer configurations, manufacturing capacity, availability of supplies or the like. As may be appreciated, in such an embodiment, step 215 takes place prior to step 210.

At step 220, an optimization across manufacturing plants is conducted by the plant optimization module 202, as will be discussed below in greater detail in connection with FIGS. 5 and 6. Essentially, such an optimization determines the best location to manufacture the ordered transformer based on a plurality of conditions, which may also include conditions that are related to business, rather than manufacturing, concerns. For example, the optimization may account for manufacturing costs and capacity at each available plant, shipping terms and location of a plant with respect to a customer location, customer credit rating, available materials and the like. As may be appreciated, any of the above factors may be weighted as desired by the manufacturer. Such weighing may be conducted by way of management server 310. At the completion of step 220, a factory location is chosen based on the above criteria. At step 225, once the optimization of step 220 has completed, a hold is placed on plant capacity and materials necessary to produce the transformer. By doing so, the optimized plant location may be held so as to prevent the subsequent placement of another order from interfering with the present order. Additional factors such as, for example, an expiration policy may be placed into effect, where the hold will be released if the order is not confirmed by a given date.

At step 230, a determination is made as to whether the order for the transformer has been confirmed. If not, the method proceeds to step 235 where the order is cancelled and any supply or factory holds are released. As may be appreciated, additional factors may be incorporated into step 235 such as, for example, the automated charging or payment of a cancellation fee, the generation of a cancellation confirmation, or the like. If, however, the determination of step 230 results in a confirned order, the method proceeds to step 240. At step 240, an automated payment plan may be initiated as agreed upon between the manufacturer and customer. The use of an automated payment plan may allow for the automatic deduction of customer funds at given production points, at the completion of production or the like.

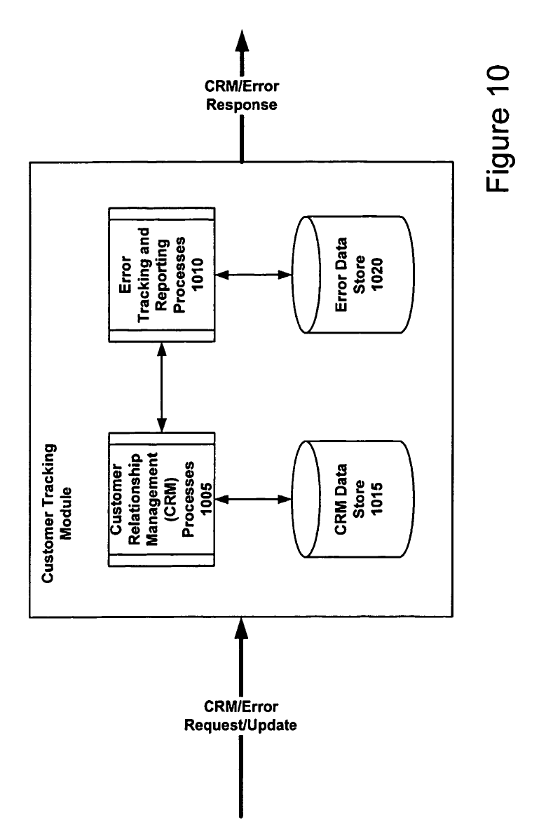

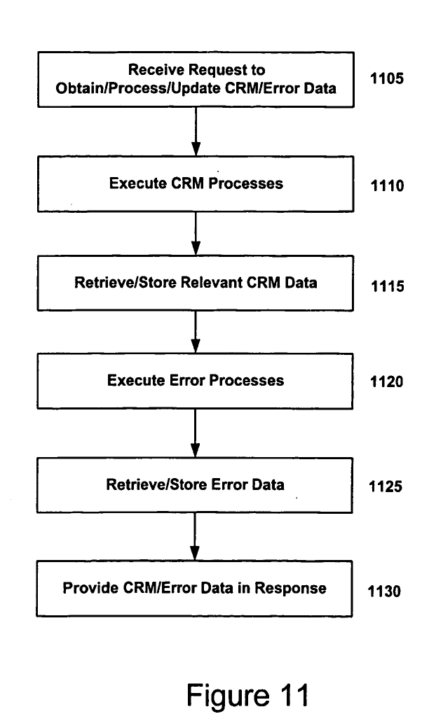

At step 245, the necessary materials and plant space are ordered and reserved, and the production of the transformer begins. In addition, the manufacturing process may be further optimized based on orders received, actual plant loading and the like. At step 250, the order and manufacturing process is completed. At such step, a customer service entity of the manufacturer may be notified to, for example, follow up with the customer and receive feedback on the ordering and manufacturing process. An example of such a following up process is described below in connection with the customer relationship management module 207 of FIGS. 10 and 11.

Plant Optimization Module

A block diagram of an exemplary manufacturing system in accordance with the present invention is shown in FIG. 5. As shown, the exemplary manufacturing system includes factories 510 and 520. Each such factory 510 and 520 includes machines 510a-d and 520a-c, respectively. As should be appreciated, a manufacturing system in accordance with the present invention may include any number of factories 510, 520 each including any number of machines 510a-d, 520a-c. Manufacturing capability input data from each factory 510 and 520 is submitted to project processing server 10a via communications network 160. Manufacturing capability information may include information such as, for example, status (online, offline, operative, non-operative, limited, full, etc.), loading, capacity and available raw materials. Such manufacturing capability input is used to perform a manufacturing optimization at project processing server 10a.

A flowchart of an exemplary method for performing a manufacturing optimization in accordance with the present invention is shown in FIG. 6. The exemplary method shown in FIG. 6 is preferably performed by a computing device such as, for example, project processing server 10a of FIG. 1b. Generally, input including orders, manufacturing capability, and optionally management preferences is received, an optimization is performed based on such input, and an optimal manufacturing location output is generated. Input parameters may be submitted from a computing device such as, for example, client computer 20a via communications network 160. The optimization is preferably performed on a global or a local scale depending on the input provided.

At step 610, order input is received. The order input preferably includes information about an order such as, for example, a size of the order, a completion/shipping date for the order, and a shipping location for the order.

At step 620, manufacturing capability input is received. The capability input may include global and/or local input. Global input preferably includes capability information about global manufacturing facilities such as, for example, factories 510 and 520. Global input may include facilities throughout the world or throughout a selected region. Local input preferably includes capability information about manufacturing components within global facilities such as, for example, machines 510a-d and 520a-c.

At step 630, management input is received. Step 630 is an optional step. Management input preferably includes information related to management policies and decisions such as, for example, manufacturing costs, wages, raw material costs, and strategic planning.

At step 640 a global or local optimization mode is selected. The optimization may be selected manually by a participating user or automatically based on factors such as, for example, the size of the order input and whether the manufacturing input is primarily global or local.

At step 650, the optimization is performed. The optimization is preferably performed by a computational engine such as, for example, computational engine 10b(2) of FIG. 1b. During optimization, the inputs received at step 610-640 are preferably processed by a plurality of artificial intelligence agents which execute at least one genetic algorithm. Computational engine 10b(2) preferably includes a neural network to realize pattern recognition and fuzzy logic for system control.

The optimization may be recalculated based on a change in input parameters due to factors such as, for example, a change in planning strategy, available materials, costs, or wages. Such a recalculation may be initiated manually in response to a request or may be initiated automatically based on a detection of a change in input parameters. For example, a participating user may request that engine 10b(2) recalculate the optimization based on a predetermined degree of a change in input parameters.

The optimization may also be performed based on anticipated future input parameters. Engine 10b(2) may calculate such future input parameters based on current values, trends, historical analysis, and/or estimates supplied by a user. The current optimization may also be recalculated by varying input parameters for testing and/or planning purposes.

At step 660, the manufacturing location output is generated. The output may include a primary optimal location and a plurality of alternate optimal locations. A participating user may select from the primary location or the alternate location based on management and planning considerations. The output may be submitted via communications network 160 to a computing device such as, for example, client computer 20a. The output may be displayed to a user at client computer 20a The output may be used as input to an application for planning a manufacturing and production schedule at the selected manufacturing location. The output may also be stored for further processing.

The output may be incorporated as part of a report, for example, to management, to potential investors, or to potential customers. Such a report may be used to plan future management decisions such as, for example, future hiring, purchase of additional manufacturing components, creation of new factories, and future allocation of existing manufacturing resources. Such a report may also be used to demonstrate manufacturing capability to potential investors and potential customers.

Supplier Integration Module

Although the various modules in system 200 are shown in communication with certain other modules, it should be appreciated that the configuration of the modules in FIG. 2 are not meant to be exclusive, but are provided merely as a means to further explain the invention. For example, in some instances supplier integration module 303 may process the customer order before plant optimization module 202, and vice versa Also, it should be appreciated that communications among the various modules may be satisfied in any number of structural contexts. For example, each of the modules may be separated by great distances, requiring communication over large networks, for example the Internet. Alternatively, the modules may all be located within a single manufacturing structure and thus communicate over a LAN. Also, it should be appreciated that each of the modules may be represented by software, and thus be located on a single and/or a distributed computing device. From this, it should be appreciated that the invention is not constrained by any particular structural context, but may be applied in any one of the embodiments listed in addition to other possible embodiments.

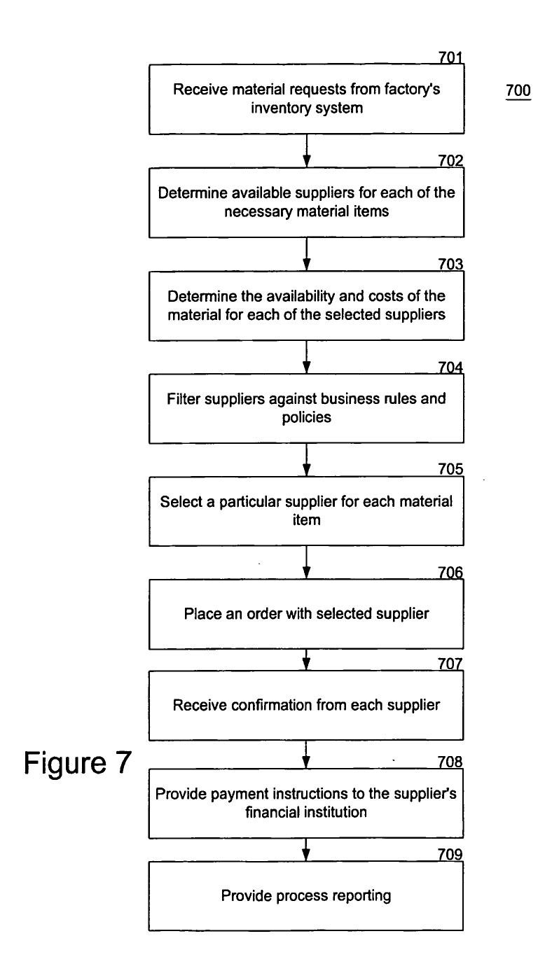

FIG. 7 is an example flow diagram 700 describing just one illustrative embodiment for implementing the invention. It should be appreciated that the flow diagram shown in FIG. 7 is just one example of a technique for accomplishing the invention. FIG. 7 is not meant to be the exclusive example, but is provided for the purpose of understanding the invention.

As shown in FIG. 7, in step 701, the system receives material requests from the factory's inventory system. In step 702, the system determines available suppliers for each of the necessary material. In step 703, the system determines the availability and costs of the material for each of the selected suppliers. In step 704, the information pertinent to each of the suppliers are filtered against certain business rules and polices. Such business rules may be applied automatically by a computing device or manually via human input and interaction. In step 705, the system selects a particular supplier for each material item. In step 706, the system provides an order (e.g., material, date of delivery, and place of delivery) with the selected supplier. In step 707, the system receives confirmation from the supplier. In step 708, the system provides payment instructions, for example electronic money transfer, to the supplier's financial institution (e.g., bank, credit agency, etc.). In step 709, the system provides feedback and trend analysis to grade each the suppliers (e.g., based on delivery due dates, material quality, and payment terms, etc.). In step 710, the system provides reporting of the information collected in step 709.

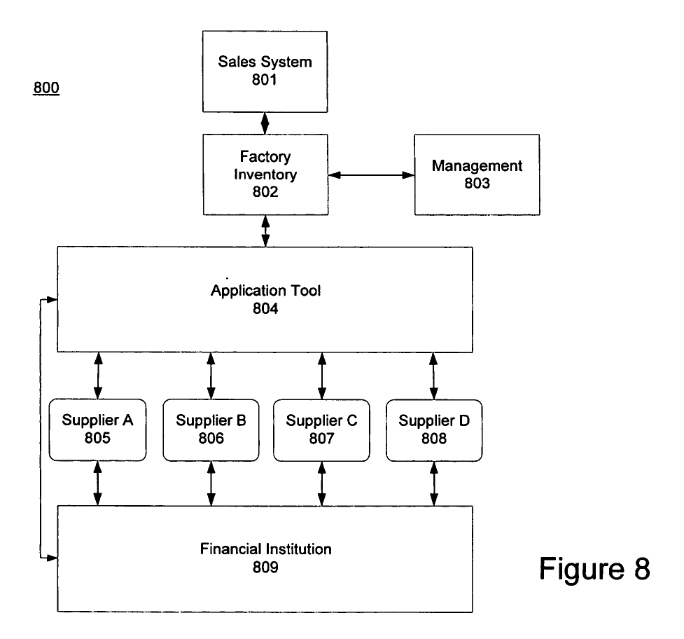

FIG. 8 is a block diagram example describing just one illustrative embodiment 800 for implementing the invention. It should be appreciated that the block diagram shown in FIG. 8 is just one example of a technique for accomplishing the invention. FIG. 8 is not meant to be the exclusive example, but is provided for the purpose of understanding the invention. In addition, although the flow diagram is discussed in the context of the manufacturing of a distribution transformer, the invention is not so limited but may be applied to the manufacturing of other products as well.

As shown in FIG. 8, a system 800 may comprise a sales system 801 that may be in communication with a factory inventory component 802. Sales system 801 may include computer processing equipment used by sales representatives to place orders for a particular type of distribution transformer via ordering module 201. Sales system 801 also may provide input directly from clients via ordering module 201. Also, communication between sales system 801 and factory inventory 802 may be accomplished over a local area network (LAN) or a wide area network (WAN), for example. Factory inventory component 802 may be a computer processing component that tracks real-time inventory, capacity, and material movement within the factory setting. For example, in the context of a distribution transformer, factory inventory component may track the availability and movement of the transformer enclosure, transformer winding items, and transformer insulation bushings. Because sales system 801 is a part of system 800, the system may be linked to material offer and acceptance process, thus providing increased reliability of promised material delivery dates.

Factory inventory component 802 may be in communication with a management component 803. Management component 803 may be computer processing equipment capable of interpreting the availability and movement of material, as provided by factory inventory 802, and providing material ordering and/or material stocking recommendations. For example, in the context of a distribution transformer, management component 803 may receive data from factory inventory 802 indicating that the in-house inventory supply of transformer insulation bushings are below expected need. As a result, this information will be provided to management component 803. Because management component 803 is an integrated part of system 800, real-time manufacturing, material inventory status, and trend and historical analysis are provided.

Factory inventory component 802 may be in communication with an application tool 804. Also, application tool 804 may be in communication with a supplier A 805, a supplier B 806, a supplier C 807, and a supplier D 808. Application tool 804 is the logic component that processes the information regarding the availability and movement of material from factory inventory 802 and the request for material and end-of-line products from sales system 801. As discussed with reference to FIG. 8, application tool 804 processes the information provided by sales system 801 and factory inventory 802 and determines what, if any, additional material is needed. Application tool 804 then identifies the relevant suppliers 805-808 that are capable of providing the needed material. There may be one or more relevant suppliers able to provide the needed material. As a result, application tool 804 determines each of the relevant supplier availability and costs. In addition, application tool 804 may make filter the relevant suppliers based on certain business rules and/or policies. These business rules and/or policies may be programmed within application tool 804, may be input on by management component 803, and/or may be input at any time based on changing business demands and supplier performance. Such information may be input to the system at any time, on a per-order basis, and/or via human interaction with the system. Once application tool 804 processes the relevant pre-programmed and/or real-time entered criteria and business rules, application tool 804 selects one or more of the relevant suppliers to provide the needed material. Application tool 804 facilitates increased material need forecasting and projection, relevant especially for critical materials that require long lead time ordering. Also, application tool 804 facilitates real-time and early cost calculations to provide up front profit margin estimates, which provide input for subsequent material price quote negotiations.

Application tool 804 may be in communication with financial institution 809. Application tool 804 may communicate with financial institution 809 to compensate the supplier or suppliers from whom application tool 804 ordered the needed materials. Also, because each of suppliers 805-808 may be in communication with one or more financial institutions 809, financial institution 809 may provide direct compensation to the selected suppliers. It should be appreciated that like the communication among the various components in system 800, application tool 804 may communicate with financial institution 809 electronically over a LAN or WAN and/or over secure financial networks. Similarly, suppliers 805-808 may receive payment from financial institution 809 electronically. It should be appreciated that each of the suppliers may have different, dedicated financial institutions to process the financial transaction.

Sales Marketing Module

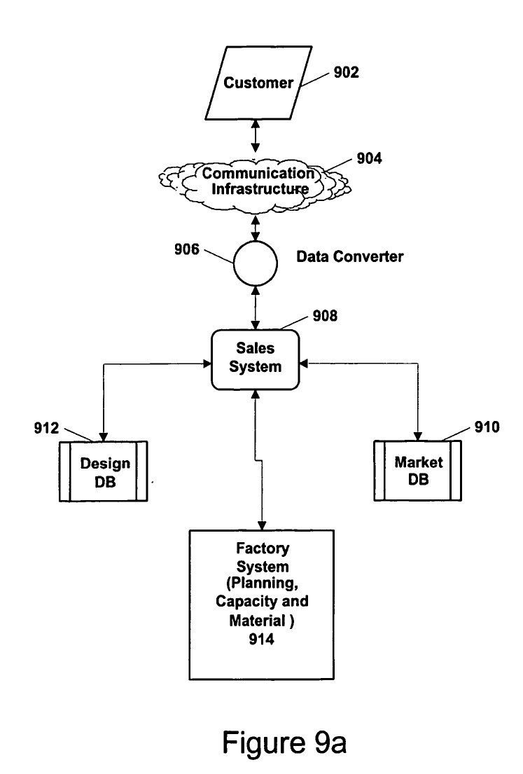

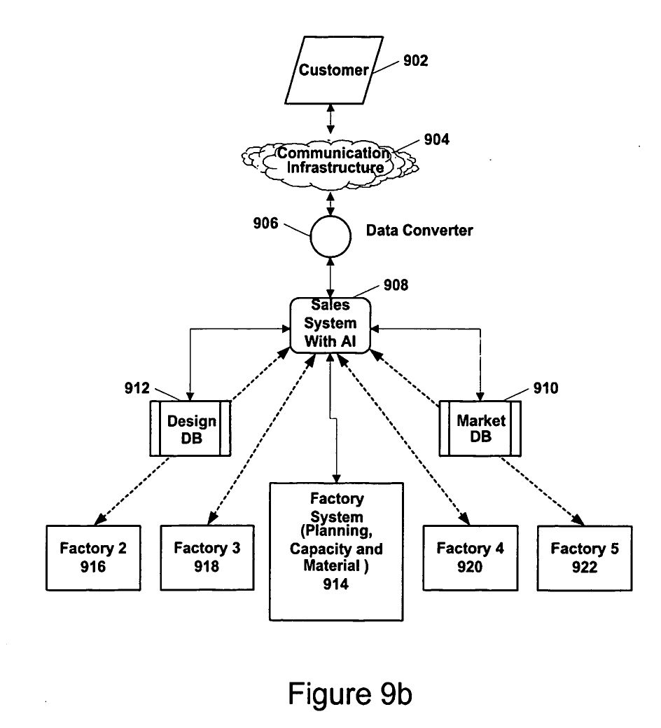

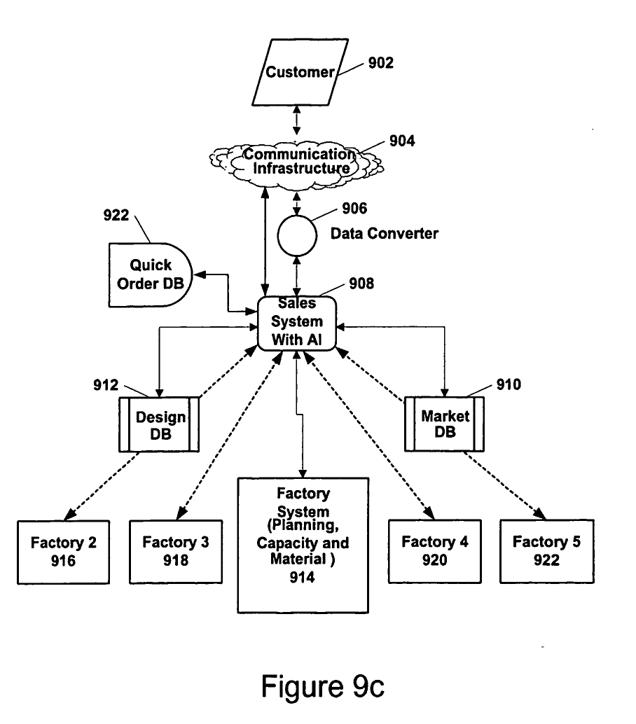

FIGS. 9a-9c show block diagrams of alternate illustrative data flow operations between exemplary components of an integrated manufacturing system 200 as described above in FIG. 2. Specifically, the data flow is of sales/marketing information communicated by the shown exemplary components to realize creation, tracking, and management of sales/marketing data for use in global power equipment manufacturing and services organizations. As shown in FIG. 9a, customer 902 may interact with sales system 908 through communications infrastructure 904 and data converter 906 to provide and obtain desired sales and marketing data for power distribution system equipment and services. Sales system 908 cooperates with design database 912, market database 910, and Factory system 914 to gather various data for processing in the creation of desired sales and marketing data

In operation, sales system 908 will send retrieve data from design database 912 and market database 910. The retrieved data is then processed with additional data communicated from factory system 914 to create sales and marketing data for power distribution equipment and services. The created data is then communicated back to the customer 902 by sales system 908 through data converter 906 and communications infrastructure 904. Specifically, sales system 908 executes one or more instruction sets that instruct at lest one execution thread to cooperate with design database 912 and market database 910 to retrieve and store power distribution equipment and services design type data and power distribution equipment and services market data, respectively. In addition, sales system 908 contains one or more instructions sets to instruct at leas one execution thread to cooperate with factory system 914. Factory system 914, among other things, provides creates and communicates data representative of planning, capacity, and material relating to power distribution system equipment and services.

For example, in an exemplary implementation, customer 902 requests a power distribution system component/service quote through the company web site (Internet). As part of this request, customer 902 may fill in a short form including transformer characteristics, project information and shipping information. The information provided by customer 902 may make its way to a sales Engineer, who is tasked to import the quote to the sales system. Sales system 908 executing one or more instruction sets, will communicate with design database 912, that may contain previous sales/design documents and drawings and retrieve a design for the requested power distribution system component. Sales system 908 may then operate to generate a bill of materials and begin manufacturing planning based on the retrieved design parameters.

From there, sales system 908 may then search through market database 910, having populated therein previous sales from previous orders and competitors' prices as well as market business conditions, to obtain pricing information for use in generating quote information for the desired power distribution system component/service. In the event that a design is not available in design database 912 as it is a newly designed power distribution system component or a special type, then an estimation of the minimum required design parameters is performed. If sales system 908 determines that the minimum design parameters is adequate for performing the estimate, sales system 908 will cooperate with a design system (not shown) to calculate those parameters and store them in design database 912 for future use.

FIGS. 9b and 9c show alternative implementations of the sales marketing module 205 of the integrated manufacturing system 200 described above in FIG. 2. Specifically, as is seen in FIG. 9b, sales system 908, instead of cooperating with a single factory to obtain information to create, track, and manage sales and marketing information for power distribution system components/services, cooperates with a plurality of factories, factory 2 916, factory 3 918, factory 4 920, and factory 5 922. In this context, in addition to the performing the above described processing, sales system 908 forwards a generated quote to a regional sales component where an automated agent will perform optimization across manufacturing plants, such as factories 510 and 520 (not shown). The optimization process will take place based on pre-determined business conditions and business logic, including but not limited to, the distance of the customer site from one or more of the power distribution system component/service manufacturing facilities, manufacturing costs, shipping terms, and customer credit rating. Additionally, sales system 908 will look to available capacity and materials to determine manufacturing capabilities to support quote realization. Additionally, sales system 908 operates such that once a factory is determined, a hold will be in place on capacity and materials to reserve a spot for that order once it is received. In an exemplary implementation, an expiration policy may be levied on the duration and extent of such hold. A confirmation may also be sent to the sales system and a quotation letter will generated with all terms and conditions of the generated quote.

At this stage, the sales engineer has the option to mail, fax and/or email that quote to the customer. Once customer accepts the quote and sales are acknowledged with that acceptance, they enter a confirmation into the sales system that forward all technical information to the appropriate manufacturing facility. Sales system 908 may also operate to perform a cost analysis on the manufactured product to determine if it is inline with the provided quote. Sales system 908 may also operate to generate reports relating to the above-described processing. In these reports information about sales trends, realized quotes or other relevant management information may be contained.

FIG. 9c shows the implementation wherein a quick order database 922 is provided in the sales marketing module 205. The quick order database serves to cache information about returning customers in an effort to speed up quote creation and communication. As is seen, sales system 908 cooperates with quick order database 922 to store and retrieve relevant customer information for use in creating, tracking, and managing sales and marketing information for customers and for use in the above-described report generation processes.

Customer Relationship Module

FIG. 10 shows a block diagram of the cooperating components of the customer relationship module 207 described in FIG. 2, and how these components interact for tracking power distribution system equipment customers. As shown, in an exemplary implementation, customer relationship module 207 comprises customer relationship management (CRM) processes 1005, CRM data store, 1015, error tracking and reporting processes 1010 and error data store 1020. In operation, a request is provided (e.g. by a participating user or cooperating component) to customer relationship module 207. The request is first processed by CRM processes 1005. Included in CRM processes 1005 is at least one instruction set to instruct to cooperate with CRM data store 1015 and error tracking and reporting process 1010 to retrieve, process, or store CRM relevant data for at least one customer relating to the sale or disposition of power distribution system equipment. From there, processing may then be passed to error tracking and reporting processes 1010. Error tracking and reporting processes 1010 cooperate with error data store 1020 and CRM processes 1005 to retrieve or store data relevant to errors encountered by customers as part of the sale or performance of power distribution system equipment or services. Included in error tracking and reporting processes 1010 is at least one instruction set providing instructions to an exemplary computing environment to communicate data to/from CRM processes 1005 and error data store 1020. Once processed, data is collected and gathered by the customer relationship module 207 to generate a CRM/Error response to the CRM/Error Request/Update. As shown by the right arrow, the response is provided for subsequent use by participating users (not shown) and/or cooperating components (not shown).

In the exemplary implementation described, CRM processes 1005 may include instruction sets to obtain or provide customer demographic, use, affinity, order history, profile, or payment history information. In addition, CRM processes 1005 may contain one or more instruction sets to track and log customer complaints surrounding the sales and/or performance of power distribution system equipment or services. Similarly, error tracking and reporting processes 1010 may include instruction sets to obtain or provide various error information for power distribution system equipment sales activities. Included in the error information is delivery error, missing equipment parts error, incorrect specifications error, and malfunctioning equipment error information.

It is appreciated that although the exemplary implementation, shows CRM processes operating first and error tracking and reporting processes operating second, that such processing order is merely exemplary as customer relationship module 207 contemplates various processing orders for these and other customer relationship module 207 components.

FIG. 11 is a flow diagram of the processing performed by the customer relationship module 207 to execute customer relationship management and/or error tracking surrounding the sales of power distribution system equipment and/or services. As shown, processing begins at block 1105 where a request is received to obtain, process, and/or update CRM/Error data. From there, processing proceeds to block 1110 where the CRM processes are executed. Relevant CRM data is then retrieved/stored (depending on the requested operation). The error tracking and reporting processes are then executed at block 1120 and the data is then retrieved and/or stored at block 1125. The processed CRM and error data is then provided in response to the received request at block 1130.

In an exemplary implementation, the above-described processing of FIG. 11 may be performed as part of or independent of a global power distribution system equipment application that manages and directs data relevant to the manufacture and sales of power distribution system equipment and/or services.

Thus, an industrial IT system for the distribution and manufacture of transformers with suppliers system integration is disclosed. While the present invention has been described in connection with the preferred embodiments of the various figures, it is to be understood that other similar embodiments may be used or modifications and additions may be made to the described embodiment for performing the same function of the present invention without deviating therefrom. Therefore, the present invention should not be limited to any single embodiment, but rather should be construed in breadth and scope in accordance with the appended claims.

1. A system for integrating customer participation in an ordering process, comprising:
a sales computer operatively connected to a customer computer, wherein the sales computer receives an order for a product from a customer by way of a website viewed on a display device of the customer computer,
a management computer operatively connected to the sales computer by way of a communications network, wherein the management computer receives order information from the sales computer,
a project processing server operatively connected to the sales computer, wherein the project processing server receives a request for an optimization across a plurality of manufacturing plants, each plant having a product manufacturing capacity, performs the optimization according to the capacity, and transmits the optimization to the sales computer; and
wherein the sales computer receives the optimization, determines whether to confirm the order and, if so, orders materials and places a hold on all or part of the capacity, and initiates an automated payment process with the customer.

2. The system of claim 1, wherein the product is an electrical power transformer.

3. The system of claim 1, wherein the order is an email transmitted by the customer computer to the sales computer by way of the communications network.

4. The system of claim 1, wherein the order is a form made available by the website and completed by the customer.

5. The system of claim 1, wherein the communications network is a first communications network, and the management computer is operatively connected to the sales computer by way of a second communications network.

6. The system of claim 5, wherein the first communications network and the second communications network are the same network.

7. The system of claim 1, wherein the sales computer reviews the order, determines whether the order is valid and, if not, transmits an error message to the customer computer.

8. The system of claim 1, wherein the management computer transmits input information to the sales computer, and wherein the sales computer determines whether to confirm the order according to the input information.

9. A method of integrating customer participation in an ordering process, comprising:
receiving an order for a product from a customer by way of a website viewed on a display device of a customer computer,
reviewing the order;
requesting an optimization across a plurality of manufacturing plants, each plant having a product manufacturing capacity, wherein the optimization takes place according to the capacity;
receiving the optimization;
determining whether to confirm the order and, if so, ordering materials and placing a hold on all or part of the capacity; and
initiating an automated payment process with the customer.

10. The method of claim 9, further comprising receiving the order as an email transmitted by the customer computer.

11. The method of claim 9, further comprising receiving the order as a completed form, wherein the form is provided by the website.

12. The method of claim 11, wherein reviewing the order comprises creating the form so as to enable the customer to select only predetermined criteria.

13. The method of claim 9, wherein reviewing the order is performed automatically by a sales computer, wherein the sales computer the sales computer is operatively connected to the customer computer by way of a communications network.

14. The method of claim 9, further comprising providing order information to a management entity.

15. The method of claim 14, further comprising receiving input information from the management entity.

16. The method of claim 15, wherein determining whether to confirm the order takes place according to the input information received from the management entity.

17. The method of claim 16, wherein determining whether to confirm the order takes place according to the input information received from the management entity.

18. The method of claim 9, further comprising providing order information to the customer.
